(19) United States
(12) Patent Application Publication
(10) Pub. No.: US 2020/0356107 A1
(43) Pub. Date: Nov. 12, 2020

(54) Walkway Detection for Autonomous Light Electric Vehicle

(71) Applicant: Uber Technologies, Inc., San Francisco, CA (US)

(72) Inventor: Alan Hugh Wells, San Rafael, CA (US)

(21) Appl. No.: 16/871,549

(22) Filed: May 11, 2020

Related U.S. Application Data
(60) Provisional application No. 62/845,916, filed on May 10, 2019.

(51) Int. Cl. G05D 1/02; G01S 11/06

(52) U.S. Cl. CPC G05D 1/0246; G01S 11/06; G06Q 30/0645; G05D 2201/0213; G05D 1/028

(57) ABSTRACT

Systems and methods for detecting walkways using sensor data from an autonomous light electric vehicle are provided. A method can include obtaining, by a computing system comprising one or more computing devices, sensor data from a sensor located onboard an autonomous light electric vehicle. The method can further include determining, by the computing system, that the autonomous light electric vehicle is located on a walkway based at least in part on the sensor data. In response to determining that the autonomous light electric vehicle is located on the walkway, the method can further include determining, by the computing system, a control action to modify an operation or a location of the autonomous light electric vehicle. The method can further include implementing, by the computing system, the control action.

### PRIORITY CLAIM

The present application is based on and claims benefit of U.S. Provisional Application 62/845,916 having a filing date of May 10, 2019, which is incorporated by reference herein.

### FIELD

The present disclosure relates generally to devices, systems, and methods for detecting walkways using sensor data from an autonomous light electric vehicle.

### BACKGROUND

Light electric vehicles (LEVs) can include passenger carrying vehicles that are powered by a battery, fuel cell, and/or hybrid-powered. LEVs can include, for example, bikes and scooters. Entities can make LEVs available for use by individuals. For instance, an entity can allow an individual to rent/lease an LEV upon request on an on-demand type basis. The individual can pick-up the LEV at one location, utilize it for transportation, and leave the LEV at another location so that the entity can make the LEV available for use by other individuals.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for determining an autonomous light electric vehicle location. The method can include obtaining, by a computing system comprising one or more computing devices, sensor data from a sensor located onboard an autonomous light electric vehicle. The method can further include determining, by the computing system, that the autonomous light electric vehicle is located on a walkway based at least in part on the sensor data. In response to determining that the autonomous light electric vehicle is located on the walkway, the method can further include determining, by the computing system, a control action to modify an operation or a location of the autonomous light electric vehicle. The method can further include implementing, by the computing system, the control action.

Another example aspect of the present disclosure is directed to a computing system. The computing system can include one or more processors and one or more tangible, non-transitory computer readable media that store instructions that when executed by the one or more processors cause the computing system to perform operations. The operations can include obtaining sensor data from a sensor located onboard an autonomous light electric vehicle. The operations can further include determining that the autonomous light electric vehicle is located on a walkway based at least in part on the sensor data. In response to determining that the autonomous light electric vehicle is located on the walkway, the operations can further include determining a control action to modify an operation or a location of the autonomous light electric vehicle. The operations can further include implementing the control action.

Another example aspect of the present disclosure is directed to an autonomous light electric vehicle. The autonomous light electric vehicle can include one or more sensors, one or more processors, and one or more tangible, non-transitory computer readable media that store instructions that when executed by the one or more processors cause the computing system to perform operations. The operations can include obtaining sensor data from the one or more sensors. The operations can further include determining that the autonomous light electric vehicle is located on a walkway based at least in part on the sensor data. In response to determining that the autonomous light electric vehicle is located on the walkway, the operations can further include determining a control action to modify an operation or a location of the autonomous light electric vehicle. The operations can further include implementing the control action.

Other aspects of the present disclosure are directed to various computing systems, vehicles, apparatuses, tangible, non-transitory, computer-readable media, and computing devices.

The technology described herein can help improve the safety of passengers of an autonomous LEV, improve the safety of the surroundings of the autonomous LEV, improve the experience of the rider and/or operator of the autonomous LEV, as well as provide other improvements as described herein. Moreover, the autonomous LEV technology of the present disclosure can help improve the ability of an autonomous LEV to effectively provide vehicle services to others and support the various members of the community in which the autonomous LEV is operating, including persons with reduced mobility and/or persons that are underserved by other transportation options. Additionally, the autonomous LEV of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous light electric vehicle computing system according to example aspects of the present disclosure;

FIG. 2 depicts an example walkway and walkway sections according to example aspects of the present disclosure;

FIG. 3A depicts an example image of a walkway and street according to example aspects of the present disclosure;

FIG. 3B depicts an example image segmentation of the example image of the walkway and street according to example aspects of the present disclosure;

FIG. 4 depicts an example method according to example aspects of the present disclosure;

FIG. 5 depicts an example control action decision tree according to example aspects of the present disclosure; and

FIG. 6 depicts example system components according to example aspects of the present disclosure.

### DETAILED DESCRIPTION

Example aspects of the present disclosure are directed to systems and methods for detecting walkways using data from sensors located onboard autonomous light electric vehicles (LEVs). For example, an autonomous LEV can be an electric-powered bicycle, scooter, or other light vehicle, and can be configured to operate in a variety of operating modes, such as a manual mode in which a human operator controls operation, a semi-autonomous mode in which a human operator provides some operational input, or a fully autonomous mode in which the autonomous LEV can travel, navigate, operate, etc. without human operator input.

LEVs have increased in popularity in part due to their ability to help reduce congestion, decrease emissions, and provide convenient, quick, and affordable transportation options, particularly within densely populated urban areas. For example, in some implementations, a rider can rent a LEV to travel a relatively short distance, such as several blocks in a downtown area. However, as the popularity of LEVs increases, restrictions may be placed on LEVs. Such restrictions may include, for example, restrictions on where LEVs can be operated and/or parked when not in use, as well as limitations on how fast LEVs can travel. For example, certain municipalities may not allow LEVs to operate on walkways, may allow walkway operation only in certain conditions (e.g., at particular times of day, in particular sections of a walkway, below certain speeds, etc.) and/or may only allow LEVs to be parked in certain areas when not in use.

The systems and methods of the present disclosure can allow for compliance with such potential restrictions, by, for example, allowing for an autonomous LEV to determine when the autonomous LEV is located on a walkway. A walkway can include a pedestrian walkway such as, for instance, sidewalks, crosswalks, walking paths, designated paths, etc. For example, to assist with autonomous operation, an autonomous LEV can include various sensors. Such sensors can include accelerometers (e.g., inertial measurement units), cameras (e.g., fisheye cameras, infrared cameras, etc.), radio beacon sensors (e.g., Bluetooth low energy sensors), GPS sensors (e.g., GPS receivers/transmitters), and/or other sensors configured to obtain data indicative of an environment in which the autonomous LEV is operating.

According to example aspects of the present disclosure, a computing system can obtain sensor data from one or more sensors located onboard the autonomous LEV. For example, in some implementations, the computing system can be located onboard the autonomous LEV. In some implementations, the computing system can be a remote computing system, and can be configured to receive sensor data from one or more autonomous LEVs, such as over a communications network. For example, an autonomous LEV can send sensor data to a remote computing device via a communication device (e.g., a cellular transmitter) over a communications network.

Further, the computing system can determine that the autonomous LEV is located on a walkway based at least in part on the sensor data. For example, in some implementations, the computing system can analyze accelerometer data for a walkway signature waveform. For example, as an autonomous LEV travels over cracks on a walkway, an accelerometer onboard the autonomous LEV can record a corresponding walkway signature waveform caused by the wheels travelling over the cracks. In some implementations, the computing system can analyze one or more images obtained from a camera located on the autonomous LEV, such as by using one or more machine-learned models. For example, an image segmentation model can be trained to detect a walkway on which the autonomous LEV is located. Similarly, a position identifier recognition model can be trained to recognize various position identifiers in the one or more images, such as QR codes visibly positioned at known locations, to determine a location of the autonomous LEV and, by extension, whether the autonomous LEV is located on a walkway. In some implementations, a visual localization model can compare the one or more images to an image map of a geographic area to determine a location of the autonomous LEV. In some implementations, the computing system can analyze the signal strength from one or more radio beacons located at one or more known locations to determine a location of the autonomous LEV. In some implementations, GPS data can indicate that the autonomous LEV is located in an area in which walkways are present. In some implementations, sensor data from a plurality of sensors can be input into a state estimator to determine the location of the autonomous LEV. For example, GPS data can indicate the autonomous LEV is in a general area in which one or more walkways are present, and a walkway signature waveform can further indicate that the autonomous LEV is operating on a walkway.

In some implementations, the computing system can determine a particular section of the walkway in which the autonomous LEV is located, such as a frontage zone, a pedestrian throughway, or a furniture zone. For example, the frontage zone of a walkway can generally be adjacent to buildings, and can include areas such as storefronts and outdoor dining areas, the furniture zone can be the section of the walkway closest to the street, and can include light poles, trees, benches, etc., and the pedestrian throughway can be the section between the frontage zone and the furniture zone where pedestrians primarily travel. In some implementations, the computing system can determine in which section of the walkway the autonomous LEV is located, such as by semantically segmenting images to identify walkway sections or using radio beacon, GPS sensors, images, or other sensor data, as described herein, to determine a location of the autonomous LEV on a particular section of the walkway. For example, once the location of the autonomous LEV is determined, the computing system can compare the location of the autonomous LEV to a map or other database of walkway sections to determine in which section of the walkway the autonomous LEV is located.

In response to determining that the autonomous LEV is located on the walkway, the computing system can determine a control action to modify an operation or a location of the autonomous LEV. For example, in various implementations, the control action can be determined based at least in part on compliance parameters, rider feedback, and/or a rider history. For example, the control action can include sending a push notification to a computing device associated with a rider (e.g., a walkway violation alert), adjust an operating speed of the autonomous LEV (e.g., reduce the speed below a threshold), controlling the autonomous LEV to a stop (e.g., ceasing operation), prevent a rider from riding an autonomous LEV at a future time (e.g., disable an account, such as for a certain time period due to repeated violations), send a relocation request to a relocation service (e.g., to relocate the autonomous LEV to a designated parking area), autonomously move the autonomous LEV (e.g., to relocate the autonomous LEV to a designated parking area) and/or other control actions.

In some implementations, the control action can depend on the section of the walkway in which the autonomous LEV is determined to be located. For example, certain municipalities may not allow autonomous LEVs to travel above certain speeds in a pedestrian throughway section or may not allow operation of autonomous LEVs in pedestrian throughways at certain times. In response to determining that the autonomous LEV is located in the pedestrian throughway, the computing system can limit or reduce the speed of the autonomous LEV to the applicable speed restriction or control the autonomous LEV to a stop. Similarly, certain municipalities may require autonomous LEVs to be parked in the furniture zone of the walkway. In response to determining that the autonomous LEV has been parked in the pedestrian throughway or the frontage zone, the computing system can send a push notification to a rider's computing device alerting the rider to the parking violation, send a relocation request to a relocation service, or, in some implementations, autonomously move the autonomous LEV to the furniture zone.

The systems and methods of the present disclosure can provide any number of technical effects and benefits. More particularly, the systems and methods of the present disclosure provide improved techniques for detecting walkways and walkway sections on which an autonomous LEV is located. For example, as described herein, a computing system can determine when an autonomous LEV is located on a walkway and/or a particular section of a walkway using sensor data obtained from one or more sensors onboard the autonomous LEV. For example, sensor data from an accelerometer can be used to determine whether the autonomous LEV is located on a walkway by analyzing accelerometer data for a walkway signature waveform. Similarly, images obtained from a camera can be analyzed using one or more machine-learned models, such as image segmentation models, position identifier recognition models, or visual localization models to detect walkways, walkway sections, and/or determine a location of the autonomous LEV. Other sensor data, such as radio beacon data and/or GPS data can also be used to determine a location of an autonomous LEV. Moreover, in response to determining that the autonomous LEV is located on a walkway, the computing system can determine and implement one or more control actions to modify an operation or a location of the autonomous LEV. For example, the computing system can alert the rider to a walkway violation, slow or stop the autonomous LEV, send a relocation request to a relocation service provider, autonomously move the autonomous LEV, or perform other control actions.

In turn, the systems and methods described herein can improve compliance with applicable restrictions. For example, by enabling detection of an autonomous LEV being located on a walkway, the operation and/or location of the light autonomous electric vehicle can be proactively managed in order to help ensure compliance. For example, in implementations in which walkway operation is allowed, the operation of an autonomous LEV can be controlled to function within acceptable speed ranges and/or only be allowed on acceptable walkway sections. Further, parking compliance can be actively managed for autonomous LEVs, such as by detecting when an autonomous LEV has been parked in an unauthorized section of a walkway, and taking one or more actions to relocate the autonomous LEV. For example, in various implementations, a rider can be alerted to a parking violation by receiving a push notification to his/her smartphone, a relocation request can be communicated to a relocation service to manually relocate the autonomous LEV, and/or the autonomous LEV can be autonomously moved to an authorized parking area.

Moreover, the systems and methods described herein can increase the safety of LEV operation, both for riders and walkway pedestrians. For example, the likelihood of an interaction between a pedestrian and a LEV can be reduced by controlling an autonomous LEV to a stop upon detecting that the autonomous LEV is located on a walkway where walkway operation of LEVs is not allowed due to heavy pedestrian traffic or by reducing a maximum speed of an autonomous LEV when operating on a walkway. Further, by relocating improperly parked autonomous LEVs, such as by autonomously moving an autonomous LEV from a pedestrian throughway to an authorized parking location, walkway congestion can be improved for pedestrians.

Example aspects of the present disclosure can provide an improvement to vehicle computing technology, such as autonomous LEV computing technology. For example, the systems and methods of the present disclosure provide an improved approach to detecting walkway operation of an autonomous LEV. For example, a computing system (e.g., a computing system on board an autonomous LEV) can obtain sensor data from a sensor located onboard an autonomous LEV. The sensor can be, for example, an accelerometer, a camera, a radio beacon sensor, and/or a GPS sensor. The computing system can further determine that the autonomous LEV is located on a walkway based at least in part on the sensor data. For example, the computing system can analyze the sensor data to detect a walkway or to determine a location of the autonomous LEV. In response to determining that the autonomous LEV is located on the walkway, the computing system can determine a control action to modify an operation or a location of the autonomous LEV. Further, the computing system can implement the control action. For example, the computing system can send a push notification to a computing device associated with a rider of the autonomous LEV, adjust an operating speed of the autonomous LEV, control the autonomous LEV to a stop, prevent future operation of the autonomous LEV by the rider, send a relocation request to a relocation service, autonomously move the autonomous LEV, request feedback from a rider, etc.

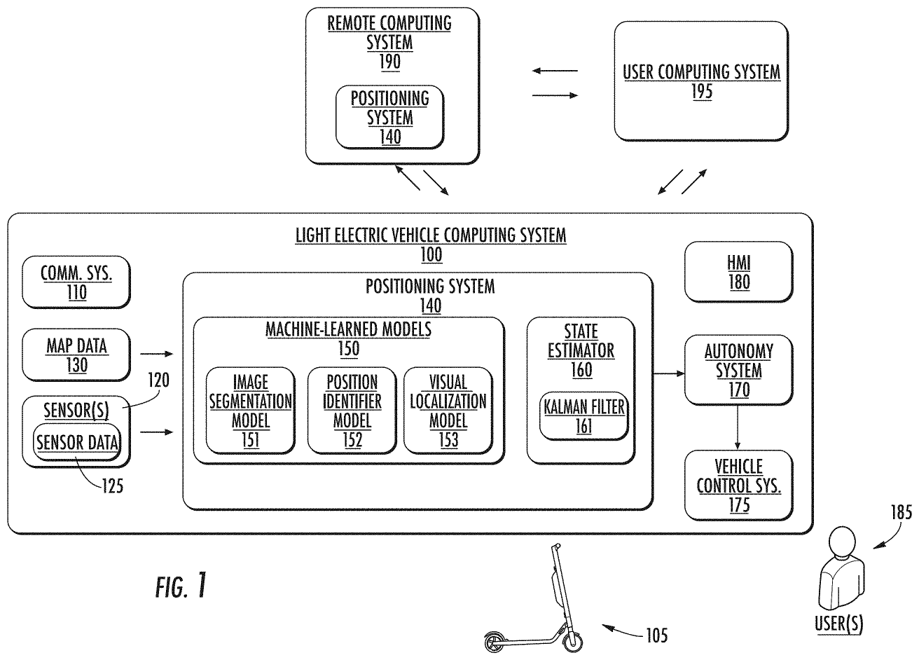

With reference now to the FIGS., example aspects of the present disclosure will be discussed in further detail. FIG. 1 illustrates an example LEV computing system 100 according to example aspects of the present disclosure. The LEV computing system 100 can be associated with an autonomous LEV 105. The LEV computing system 100 can be located onboard (e.g., included on and/or within) the autonomous LEV 105.

The autonomous LEV 105 incorporating the LEV computing system 100 can be various types of vehicles. For instance, the autonomous LEV 105 can be a ground-based autonomous LEV such as an electric bicycle, an electric scooter, an electric personal mobility vehicle, etc. The autonomous LEV 105 can travel, navigate, operate, etc. with minimal and/or no interaction from a human operator (e.g., rider/driver). In some implementations, a human operator can be omitted from the autonomous LEV 105 (and/or also omitted from remote control of the autonomous LEV 105). In some implementations, a human operator can be included in the autonomous LEV 105, such as a rider and/or a remote operator.

In some implementations, the autonomous LEV 105 can be configured to operate in a plurality of operating modes. The autonomous LEV 105 can be configured to operate in a fully autonomous (e.g., self-driving) operating mode in which the autonomous LEV 105 is controllable without user input (e.g., can travel and navigate with no input from a human operator present in the autonomous LEV 105 and/or remote from the autonomous LEV 105). The autonomous LEV 105 can operate in a semi-autonomous operating mode in which the autonomous LEV 105 can operate with some input from a human operator present in the autonomous LEV 105 (and/or a human operator that is remote from the autonomous LEV 105). The autonomous LEV 105 can enter into a manual operating mode in which the autonomous LEV 105 is fully controllable by a human operator (e.g., human rider, driver, etc.) and can be prohibited and/or disabled (e.g., temporary, permanently, etc.) from performing autonomous navigation (e.g., autonomous driving). In some implementations, the autonomous LEV 105 can implement vehicle operating assistance technology (e.g., collision mitigation system, power assist steering, etc.) while in the manual operating mode to help assist the human operator of the autonomous LEV 105.

The operating modes of the autonomous LEV 105 can be stored in a memory onboard the autonomous LEV 105. For example, the operating modes can be defined by an operating mode data structure (e.g., rule, list, table, etc.) that indicates one or more operating parameters for the autonomous LEV 105, while in the particular operating mode. For example, an operating mode data structure can indicate that the autonomous LEV 105 is to autonomously plan its motion when in the fully autonomous operating mode. The LEV computing system 100 can access the memory when implementing an operating mode.

The operating mode of the autonomous LEV 105 can be adjusted in a variety of manners. For example, the operating mode of the autonomous LEV 105 can be selected remotely, off-board the autonomous LEV 105. For example, a remote computing system 190 (e.g., of a vehicle provider and/or service entity associated with the autonomous LEV 105) can communicate data to the autonomous LEV 105 instructing the autonomous LEV 105 to enter into, exit from, maintain, etc. an operating mode. By way of example, such data can instruct the autonomous LEV 105 to enter into the fully autonomous operating mode. In some implementations, the operating mode of the autonomous LEV 105 can be set onboard and/or near the autonomous LEV 105. For example, the LEV computing system 100 can automatically determine when and where the autonomous LEV 105 is to enter, change, maintain, etc. a particular operating mode (e.g., without user input). Additionally, or alternatively, the operating mode of the autonomous LEV 105 can be manually selected via one or more interfaces located onboard the autonomous LEV 105 (e.g., key switch, button, etc.) and/or associated with a computing device proximate to the autonomous LEV 105 (e.g., a tablet operated by authorized personnel located near the autonomous LEV 105). In some implementations, the operating mode of the autonomous LEV 105 can be adjusted by manipulating a series of interfaces in a particular order to cause the autonomous LEV 105 to enter into a particular operating mode. In some implementations, the operating mode of the autonomous LEV 105 can be selected via a user computing device 195, such as when a user 185 uses an application operating on the user computing device 195 to access or obtain permission to operate an autonomous LEV 105, such as for a short-term rental of the autonomous LEV 105.

In some implementations, the remote computing system 190 can communicate indirectly with the autonomous LEV 105. For example, the remote computing system 190 can obtain and/or communication data to and/or from a third party computing system, which can then obtain/communicate data to and/or from the autonomous LEV 105. The third party computing system can be, for example, the computing system of an entity that manages, owns, operates, etc. one or more autonomous LEVs. The third party can make their autonomous LEV(s) available on a network associated with the remote computing system 190 (e.g., via a platform) so that the autonomous vehicles LEV(s) can be made available to user(s) 185.

The LEV computing system 100 can include one or more computing devices located onboard the autonomous LEV 105. For example, the computing device(s) can be located on and/or within the autonomous LEV 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous LEV 105 (e.g., its computing system, one or more processors, etc.) to perform operations and functions, such as those described herein for detecting walkways and implementing control actions, etc.

The autonomous LEV 105 can include a communications system 110 configured to allow the LEV computing system 100 (and its computing device(s)) to communicate with other computing devices. The LEV computing system 100 can use the communications system 110 to communicate with one or more computing device(s) that are remote from the autonomous LEV 105 over one or more networks (e.g., via one or more wireless signal connections). For example, the communications system 110 can allow the autonomous LEV to communicate and receive data from a remote computing system 190 of a service entity (e.g., an autonomous LEV rental entity), a third party computing system, and/or a user computing system 195 (e.g., a user's smart phone). In some implementations, the communications system 110 can allow communication among one or more of the system(s) on-board the autonomous LEV 105. The communications system 110 can include any suitable components for interfacing with one or more network(s), including, for example, transmitters, receivers, ports, controllers, antennas, and/or other suitable components that can help facilitate communication.

As shown in FIG. 1, the autonomous LEV 105 can include one or more vehicle sensors 120, a positioning system 140, an autonomy system 170, one or more vehicle control systems 175, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 120 can be configured to acquire sensor data 125. The vehicle sensor(s) 120 can include a Light Detection and Ranging (LIDAR) system, a Radio Detection and Ranging (RADAR) system, one or more cameras (e.g., fisheye cameras, visible spectrum cameras, infrared cameras, etc.), ultrasonic sensors, wheel encoders, steering angle encoders, positioning sensors (e.g., GPS sensors), accelerometers, inertial measurement units (which can include one or more accelerometers and/or gyroscopes), radio beacon sensors (e.g., Bluetooth low energy sensors), motion sensors, inertial sensors, and/or other types of imaging capture devices and/or sensors. The sensor data 125 can include inertial measurement unit/accelerometer data, image data, RADAR data, LIDAR data, radio beacon sensor data, GPS sensor data, and/or other data acquired by the vehicle sensor(s) 120. This can include sensor data 125 associated with the surrounding environment of the autonomous LEV 105. For instance, the sensor data 125 can include image and/or other data within a field of view of one or more of the vehicle sensor(s) 120. The sensor data 125 can also include sensor data 125 associated with the autonomous LEV 105. For example, the autonomous LEV 105 can include inertial measurement unit(s) (e.g., gyroscopes and/or accelerometers), wheel encoders, steering angle encoders, and/or other sensors.

In some implementations, the sensor data 125 can be indicative of a walkway on which the autonomous LEV is located and/or a section of a walkway in which the autonomous LEV is located. For example, image data can depict a walkway and/or walkway sections, and accelerometer data can indicate the autonomous LEV is travelling on a walkway, as described herein. In some implementations, the sections of a walkway can include a first section (e.g., a frontage zone nearest to one or more buildings or store fronts), a second section (e.g., a furniture zone nearest to a street), a third section (e.g., a pedestrian throughway between the frontage zone and the furniture zone), and/or other section(s). In some implementations, the sensor data 125 can be indicative of a location, such as GPS data, radio beacon sensor data (e.g., a Bluetooth low energy beacon signal strength from a radio beacon at a known/fixed locations), and/or position identifier data (e.g., image data depicting QR codes positioned at known/fixed locations). In some implementations, the sensor data 125 can be indicative of one or more objects within the surrounding environment of the autonomous LEV 105. The object(s) can be located in front of, to the rear of, to the side of the autonomous LEV 105, etc. For example, image data from a fisheye camera can capture a wide field of view, such as a 180 degree viewing angle, and can depict objects, buildings, surfaces, etc. within the field of view. In some implementations, a fisheye camera can be a forward-facing fisheye camera, and can be configured to obtain image data which includes one or more portions of the autonomous LEV 105 and the orientation and/or location of the one or more portions of the autonomous LEV 105 in the surrounding environment. The sensor data 125 can be indicative of locations associated with the object(s) within the surrounding environment of the autonomous LEV 105 at one or more times. The vehicle sensor(s) 120 can communicate (e.g., transmit, send, make available, etc.) the sensor data 125 to the positioning system 140.

In addition to the sensor data 125, the LEV computing system 100 can retrieve or otherwise obtain map data 145. The map data 145 can provide information about the surrounding environment of the autonomous LEV 105. In some implementations, an autonomous LEV 105 can obtain detailed map data that provides information regarding: the identity and location of different walkways, walkway sections, and/or walkway properties (e.g., spacing between walkway cracks); the identity and location of different radio beacons (e.g., Bluetooth low energy beacons); the identity and location of different position identifiers (e.g., QR codes visibly positioned in a geographic area); the identity and location of different LEV parking areas; the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the autonomous LEV 105 in comprehending and perceiving its surrounding environment and its relationship thereto. In some implementations, the LEV computing system 100 can determine a vehicle route for the autonomous LEV 105 based at least in part on the map data 145.

In some implementations, the map data 130 can include an image map, such as an image map generated based at least in part on a plurality of images of a geographic area. For example, in some implementations, an image map can be generated from a plurality of aerial images of a geographic area. For example, the plurality of aerial images can be obtained from above the geographic area by, for example, an air-based camera (e.g., affixed to an airplane, helicopter, drone, etc.). In some implementations, the plurality of images of the geographic area can include a plurality of street view images obtained from a street-level perspective of the geographic area. For example, the plurality of street-view images can be obtained from a camera affixed to a ground-based vehicle, such as an automobile. In some implementations, the image map can be used by a visual localization model 153 to determine a location of an autonomous LEV 105, as described herein.

The autonomous LEV 105 can include a positioning system 140. The positioning system 140 can obtain/receive the sensor data 125 from the vehicle sensor(s), and can determine a location (also referred to as a position) of the autonomous LEV 105. The positioning system 140 can be any device or circuitry for analyzing the location of the autonomous LEV 105. Additionally, as shown in FIG. 1, in some implementations, a remote computing system 190 can include a positioning system 140. For example, sensor data 125 from one or more sensors 120 of an autonomous LEV 105 can be communicated to the remote computing system 190 via the communications system 110, such as over a communications network.

According to example aspects of the present disclosure, the positioning system 140 can determine whether the autonomous LEV 105 is located on a walkway based at least in part on the sensor data 125 obtained from the vehicle sensor(s) 120 located onboard the autonomous LEV 105.

For example, in some implementations, the positioning system 140 can determine that the autonomous LEV 105 is located on a walkway based at least in part on accelerometer data. For example, as the autonomous LEV 105 travels on a walkway, the wheels of the autonomous LEV 105 will travel over cracks in the walkway, causing small vibrations to be recorded in the accelerometer data. The positioning system 140 can analyze the accelerometer data for a walkway signature waveform. For example, the walkway signature waveform can include periodic peaks repeated at relatively regular intervals, which can correspond to the acceleration caused by travelling over the cracks. In some implementations, the positioning system 140 can determine that the autonomous LEV 105 is located on a walkway by recognizing the walkway signature waveform.

In some implementations, the spacing between walkway cracks for a particular geographic area can be obtained by the positioning system 140, such as in the map data 130. For example, a particular municipality or geographic area may have standardized walkway crack spacing (e.g., 24 inches, 30 inches, 36 inches, etc.), which can be stored in the map data 130. In some implementations, the positioning system 140 can analyze accelerometer data for the walkway signature waveform based at least in part on the map data 130, such as by looking for the walkway signature waveform corresponding to the standardized walkway crack spacing for the particular municipality.

In some implementations, the speed of the autonomous LEV 105 can be obtained by the positioning system 140, such as via GPS data, wheel encoder data, speedometer data, or other suitable data indicative of a speed. For example, wheel encoder data for an autonomous LEV 105 can indicate that the autonomous LEV 105 is traveling at a speed of approximately 10 miles per hour (mph). In some implementations, the positioning system 140 can analyze accelerometer data for the signature waveform based at least in part on the speed of the autonomous LEV 105. For example, an autonomous LEV 105 traveling at a speed of 10 mph may travel over approximately twice as many walkway cracks in a given time period as an autonomous LEV 105 traveling at a speed of 5 mph. Thus, the accelerometer data for a vehicle travelling at a speed of 10 mph may have twice as many peaks in the given time period as a vehicle travelling at a speed of 5 mph. Stated differently, the time between accelerometer peaks can be half as much for a vehicle travelling at a speed of 10 mph as a vehicle travelling at a speed of 5 mph. In some implementations, the positioning system 140 can analyze the accelerometer data for the walkway signature waveform by detecting peaks corresponding to walkway cracks at a particular spacing interval for an autonomous LEV 105 traveling at a particular speed.

In some implementations, the positioning system 140 can determine that the autonomous LEV 105 is located on the walkway based at least in part on one or more images obtained from a camera located onboard the autonomous LEV 105. For example, one or more images obtained from a fisheye camera can be analyzed by an onboard positioning system 140, or the one or more images can be communicated to a remote positioning system 140, such as via a communications network.

In some implementations, the one or more images can be analyzed using one or more machine-learned models 150. The machine-learned models can be, for example, neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

For example, in some implementations, the positioning system 140 can include an image segmentation model 151. The image segmentation model 151 can segment or partition an image into a plurality of segments, such as, for example, a foreground, a background, a walkway, sections of a walkway, roadways, various objects (e.g., vehicles, people, trees, benches, tables, etc.), or other segments.

In some implementations, the image segmentation model 151 can be trained to detect a walkway and/or a walkway section using training data comprising a plurality of images labeled with walkway or walkway section annotations. For example, a human reviewer can annotate a training dataset which can include a plurality of images of walkways and/or walkway sections. The human reviewer can segment and annotate each image in the training dataset with labels corresponding to each segment. For example, walkways and/or walkway sections (e.g., frontage zone, furniture zone, a pedestrian throughway) in the images in the training dataset can be labeled, and the image segmentation model 151 can be trained using any suitable machine-learned model training method (e.g., back propagation of errors). Once trained, the image segmentation model 151 can receive an image, such as an image from a fisheye camera located onboard an autonomous LEV 105, and can segment the image in order to detect walkways and/or walkway sections.

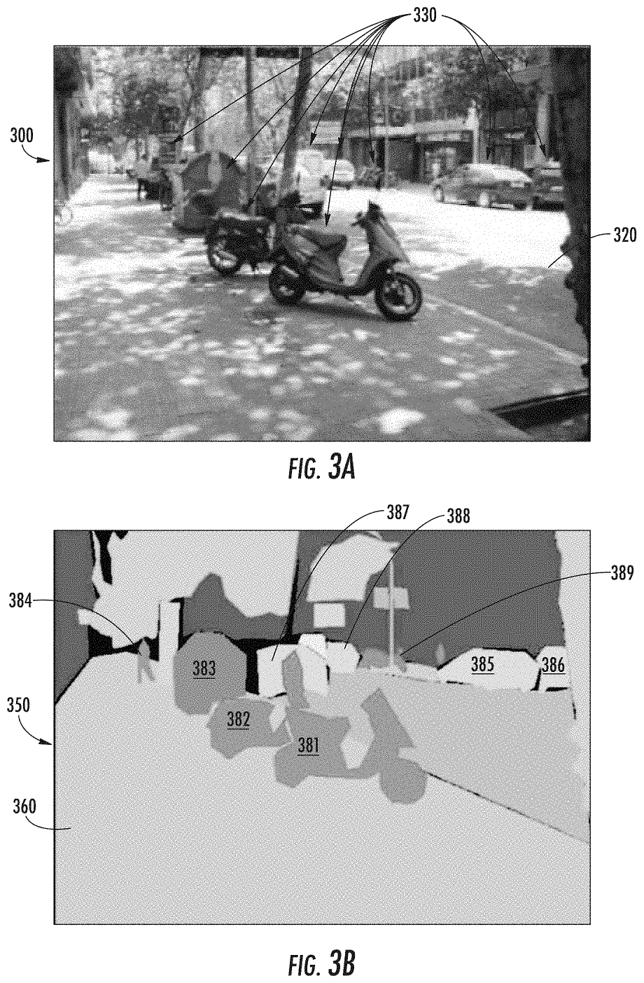

Further, based on the orientation of the walkway and/or walkway sections in an image, the positioning system 140 can determine that the autonomous LEV is located on a walkway and/or a particular walkway section. For example, in some implementations, an image captured from a fisheye camera can include a perspective view of the autonomous LEV 105 located on the walkway or show the walkway on both a left side and a right side of the autonomous LEV 105, and therefore indicate that the autonomous LEV 105 is located on the walkway. An example of an image segmented into objects, roads, and a walkway using an example image segmentation model 151 is depicted in FIG. 3.

In some implementations, the one or more machine-learned models 150 can include one or more position identifier recognition models 152. For example, the position identifier recognition model 152 can be trained to recognize one or more position identifiers, such as QR codes, in an image. As an example, in some implementations, a plurality of QR codes can be visibly positioned within a geographic area in which an autonomous LEV 105 is located, such as a downtown area of a city. For example, each QR code can be positioned on a street corner, a corner of a building, a store front, a street sign, etc. where it can be visible from a walkway, such as at a height of 10 feet above the ground. The position identifier recognition model 152 can be trained to recognize the QR codes, and further determine the location of the autonomous LEV 105 based at least in part on the one or more QR codes depicted in an image. For example, the location of each QR code can be stored in the map data 130, and can be accessed by the position identifier recognition model 152 to determine the location of the autonomous LEV 105. The position identifier recognition model 152 can use, for example, the relative size of one or more QR code(s), the orientation/perspective of the one or more QR code(s), an orientation of a first QR code with respect to a second QR code, etc. to determine a location of the autonomous LEV 105. The location of the autonomous LEV 105 can then be compared to a map or database of walkways and/or walkway sections to determine whether the autonomous LEV 105 is located on a walkway and/or a section of the walkway in which the autonomous LEV 105 is located.

In some implementations, the one or more machine-learned models 150 can include a visual localization model 153. For example, the visual localization model 153 can be trained to determine a location of the autonomous LEV 105 by comparing one or more images to an image map. For example, map data 130 can include an image map, which can be a map of a geographic area generated based at least in part on a plurality of images of the geographic area, such as aerial images and/or street-view images. The visual localization model 153 can match one or more images to a corresponding location on the image map in order to determine the location of the autonomous LEV 105. The location of the autonomous LEV 105 can then be compared to known locations of walkways and/or walkway sections, in order to determine whether the autonomous LEV 105 is located on a walkway and/or in a walkway section.

In some implementations, additional positioning data, such as GPS data, can be used to first determine a subset of the image map in which the autonomous LEV 105 is located, such as within a one block radius. The visual localization model 153 can then compare one or more images from the autonomous LEV 105 to the subset of the image map to determine the location of the autonomous LEV 105.

In some implementations, the positioning system 140 can determine the location of the autonomous LEV 105 based at least in part on a signal received from one or more radio beacons. For example, a strength of a signal received from one or more radio beacons (e.g., Bluetooth low energy beacons) can be analyzed to determine the location of the autonomous LEV 105. For example, a radio beacon sensor can be a Bluetooth low energy sensor onboard an autonomous LEV, and can be configured to transmit/receive universally unique identifier(s) using Bluetooth low energy proximity sensing. The Bluetooth low energy sensor can receive signals from Bluetooth beacons positioned at known locations in a geographic area. For example, a downtown area of a city can include a plurality of Bluetooth beacons positioned at known locations and each beacon can transmit a unique identifier. The positions of the respective beacons and their unique identifiers can be stored, for example, as map data 130 which can be accessed by the positioning system 140. The positioning system 140 can determine the location of the autonomous LEV 105 by, for example, analyzing the signal strength from one or more Bluetooth beacons to determine a proximity to the respective beacons. The positioning system 140 can then use the known location of a particular beacon and the proximity to that beacon to determine the location of the autonomous LEV 105. In some implementations, the positioning system 140 can use radio beacon data from a plurality of beacons to determine a location of the autonomous LEV (e.g., using triangulation). The positioning system 140 can then compare the location of the autonomous LEV 105 to known locations of walkways and/or walkway sections stored in map data 130 to determine whether the autonomous LEV 105 is located on a walkway and/or a section of the walkway in which the autonomous LEV 105 is located.

In some implementations, the positioning system 140 can determine the location of the autonomous LEV 105 based at least in part on GPS data. For example, GPS data can indicate that the autonomous LEV 105 is located in an area which includes one or more walkways. The location(s) of walkway(s) can be stored as map data 130.

In some implementations, the positioning system 140 can determine that the autonomous LEV 105 is located on a walkway based at least in part on sensor data from a plurality of sensors. For example, GPS data can indicate that the autonomous LEV 105 is located in a geographic area which includes one or more walkways. Further, accelerometer data can include a walkway signature waveform, as disclosed herein, indicating the autonomous LEV 105 is located on a walkway. In some implementations, the positioning system 140 can determine that the autonomous LEV 105 is located on a walkway based at least in part on the GPS data and the accelerometer data.

In some implementations, the positioning system 140 can include a state estimator 160. For example, the state estimator can be configured to receive sensor data from a plurality of sensors and determine whether the autonomous LEV 105 is located on a walkway using the sensor data from the plurality of sensors. In some implementations, the state estimator 160 can be a Kalman filter 161.

For example, accelerometer data including a walkway signature waveform can be indicative of the autonomous LEV being located on a walkway, but the accelerometer data may include associated statistical noise. Similarly, image data analyzed by an image segmentation model 151 can be indicative of the autonomous LEV being located on a walkway, but analysis of the image data may provide less than a 100% confidence level that the autonomous LEV 105 is on the walkway. In some implementations, the accelerometer data and the image data can be input into the state estimator 160 to determine that the autonomous LEV 105 is located on the walkway.

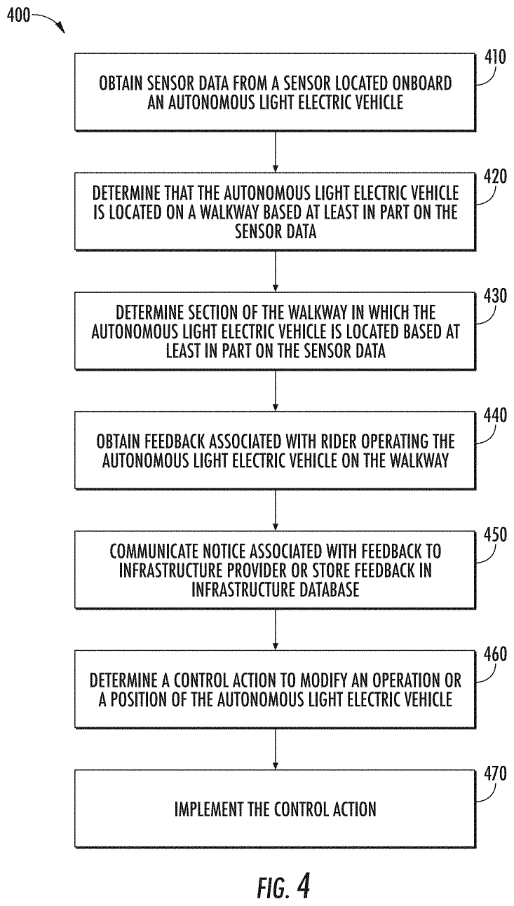

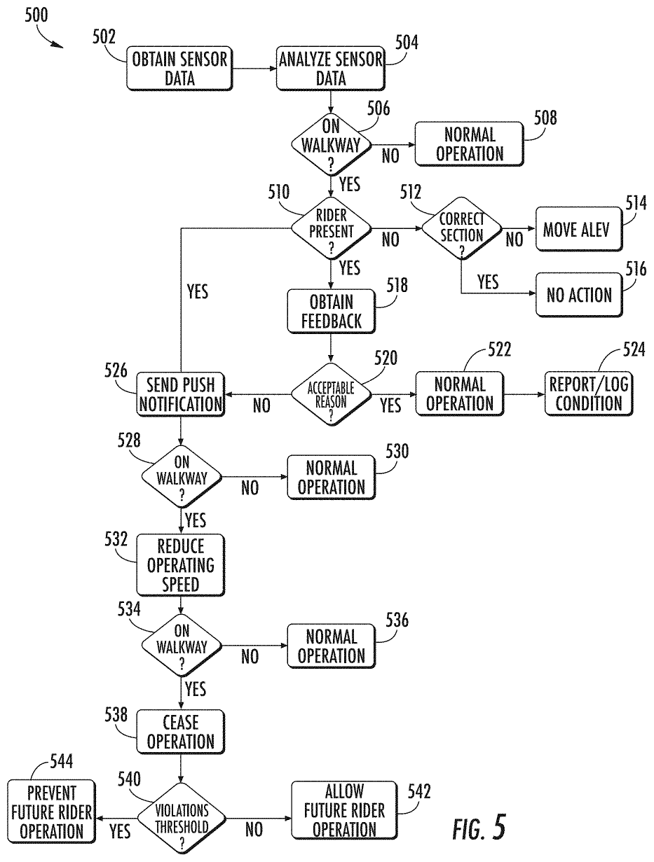

In this way, the positioning system 140 can determine the location of the autonomous LEV 105, including whether the autonomous LEV 105 is located on a walkway or in a particular walkway section. Further, as described in greater detail with respect to FIGS. 4 and 5, in response to determining that the autonomous LEV 105 is located on, a walkway, the computing system (e.g., LEV computing system 100 and/or remote computing system 190) can determine and implement a control action to modify an operation or a location of the autonomous LEV 105. For example, in some implementations, the computing system (e.g., LEV computing system 100 and/or remote computing system 190) can send a push notification to the user computing system 195 associated with a user 185 (e.g., rider) of the autonomous LEV 105, communicate a request for feedback regarding operation of the autonomous LEV 105 to the user computing system 195, adjust an operating speed of the autonomous LEV 105, control the autonomous LEV 105 to a stop, prevent the user 185 (e.g., rider) from operating an autonomous LEV 105 at a future time, send a relocation request associated with the autonomous LEV 105 to a relocation service, autonomously move the autonomous LEV 105 to a different location (e.g., by sending a motion plan or control actions to the autonomous LEV 105), or other control action.

The LEV computing system 100 can also include an autonomy system 170. For example, the autonomy system 170 can obtain the sensor data 125 from the vehicle sensor(s) 120 and position data from the positioning system 140 to perceive its surrounding environment, predict the motion of objects within the surrounding environment, and generate an appropriate motion plan through such surrounding environment.

The autonomy system 170 can communicate with the one or more vehicle control systems 175 to operate the autonomous LEV 105 according to the motion plan. In some implementations, the autonomy system 170 can receive a control action from a remote computing system 190, such as a control action or motion plan to move the autonomous vehicle 105 to a new location, and the vehicle control system 175 can perform the control action or implement the motion plan.

The autonomous LEV 105 can include an HMI (“Human Machine Interface”) 180 that can output data for and accept input from a user 185 of the autonomous LEV 105. The HMI 180 can include one or more output devices such as display devices, speakers, tactile devices, etc. In some implementations, the HMI 180 can provide notifications to a rider, such as when a rider is violating a walkway restriction.

The remote computing system 190 can include one or more computing devices that are remote from the autonomous LEV 105 (e.g., located off-board the autonomous LEV 105). For example, such computing device(s) can be components of a cloud-based server system and/or other type of computing system that can communicate with the LEV computing system 100 of the autonomous LEV 105, another computing system (e.g., a vehicle provider computing system, etc.), a user computing system 195, etc. The remote computing system 190 can be or otherwise included in a data center for the service entity, for example. The remote computing system 190 can be distributed across one or more location(s) and include one or more sub-systems. The computing device(s) of a remote computing system 190 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from vehicle(s), and determining that an autonomous LEV 105 is located on a walkway, etc.

As shown in FIG. 1, the remote computing system 190 can include a positioning system 140, as described herein. In some implementations, the remote computing system 190 can determine that the LEV 105 is located on a walkway based at least in part on sensor data 125 communicated from the LEV 105 to the remote computing system 190.

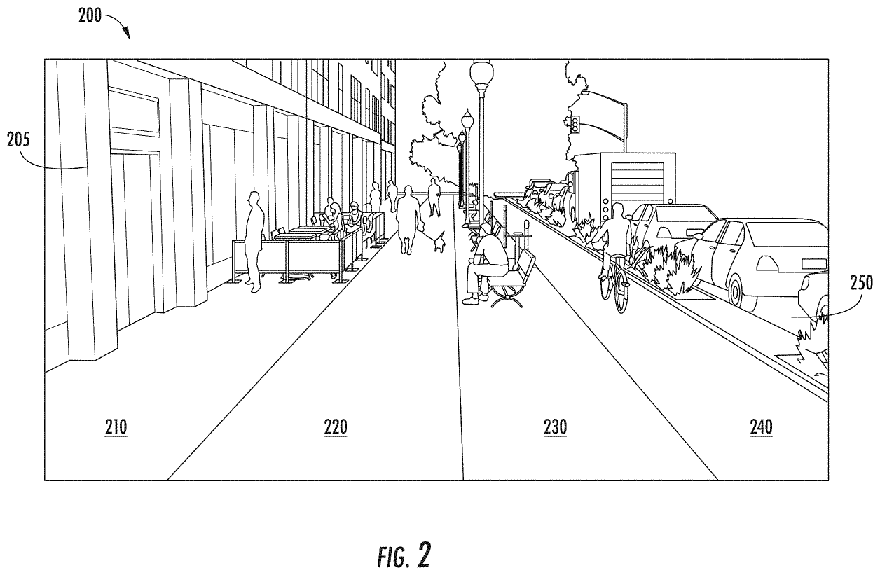

Referring now to FIG. 2, an example walkway 200 and walkway sections 210-240 according to example aspects of the present disclosure are depicted. As shown, a walkway 200 can be divided up into one or more sections, such as a first section (e.g., frontage zone 210), a second section (e.g., pedestrian throughway 220), a third section (e.g., furniture zone 230), and/or a fourth section (e.g., bicycle lane 240).

A frontage zone 210 can be a section of the walkway 200 closest to one or more buildings 205. For example, the one or more buildings 205 can correspond to dwellings (e.g., personal residences, multi-unit dwellings, etc.), retail space (e.g., office buildings, storefronts, etc.) and/or other types of buildings. The frontage zone 210 can essentially function as an extension of the building, such as entryways, doors, walkway café s, sandwich boards, etc. The frontage zone 210 can include both the structure and the façade of the buildings 205 fronting the street 250 as well as the space immediately adjacent to the buildings 205.

The pedestrian throughway 220 can be a section of the walkway 200 that functions as the primary, accessible pathway for pedestrians that runs parallel to the street 250. The pedestrian throughway 220 can be the section of the walkway 200 between the frontage zone 210 and the furniture zone 230. The pedestrian throughway 220 functions to help ensure that pedestrians have a safe and adequate place to walk. For example, the pedestrian throughway 220 in a residential setting may typically be 5 to 7 feet wide, whereas in a downtown or commercial area, the pedestrian throughway 220 may typically be 8 to 12 feet wide. Other pedestrian throughways 220 can be any suitable width.

The furniture zone 230 can be a section of the walkway 200 between the curb of the street 250 and the pedestrian throughway 220. The furniture zone 230 can typically include street furniture and amenities such as lighting, benches, newspaper kiosks, utility poles, trees/tree pits, as well as light vehicle parking spaces, such as parking spaces for bicycles and LEVs.

Some walkways 200 may optionally include a travel lane 240. For example, the travel lane 240 can be a designated travel way for use by bicycles and LEVs. In some implementations, a travel lane 240 can be a one-way travel way, whereas in others, the travel lane 240 can be a two-way travel way. In some implementations, a travel lane 240 can be a designated portion of a street 250.

Each section 210-240 of a walkway 200 can generally be defined according to its characteristics, as well as the distance of a particular section 210-240 from one or more landmarks. For example, in some implementations, a frontage zone 210 can be the 6 to 8 feet closest to the one or more buildings 205. In some implementations, a furniture zone 230 can be the 6 to 8 feet closest to the street 250. In some implementations, the pedestrian throughway 220 can be the 5 to 12 feet in the middle of a walkway 200. In some implementations, each section 210-240 can be determined based upon characteristics of each particular section 210-240, such as by semantically segmenting an image using an image segmentation model 151 depicted in FIG. 1. For example, street furniture included in a furniture zone 230 can help to distinguish the furniture zone 230, whereas sandwich boards and outdoor seating at walkway café s can help to distinguish the frontage zone 210. In some implementations, the sections 210-240 of a walkway 200 can be defined, such as in a database. For example, a particular location (e.g., a position) on a walkway 200 can be defined to be located within a particular section 210-240 of the walkway 200 in a database, such as a map data 130 database depicted in FIG. 1. In some implementations, the sections 210-240 of a walkway 200 can have general boundaries such that the sections 210-240 may have one or more overlapping portions with one or more adjacent sections 210-240.

Referring now to FIG. 3A, an example image 300 depicting a walkway 310, a street 320, and a plurality of objects 330 is depicted, and FIG. 3B depicts a corresponding semantic segmentation 350 of the image 300. For example, as shown, the semantically-segmented image 350 can be partitioned into a plurality of segments 360-389 corresponding to different semantic entities depicted in the image 300. Each segment 360-389 can generally correspond to an outer boundary of the respective semantic entity. For example, the walkway 310 can be semantically segmented into a distinct semantic entity 360, the road 320 can be semantically segmented into a distinct semantic entity 370, and each of the objects 330 can be semantically segmented into distinct semantic entities 381-389, as depicted. For example, semantic entities 381-384 are located on the walkway 360, whereas semantic entities 385-389 are located on the road 370. While the semantic segmentation depicted in FIG. 3 generally depicts the semantic entities segmented to their respective borders, other types of semantic segmentation can similarly be used, such as bounding boxes etc.

In some implementations, individual sections of a walkway 310 can also be semantically segmented. For example, an image segmentation model 151 depicted in FIG. 1 can be trained to semantically segment a walkway into one or more of a frontage zone, a pedestrian throughway, a furniture zone, and/or a bicycle lane, as depicted in FIG. 2.

FIG. 4 depicts a flow diagram of an example method 400 for determining whether an autonomous LEV is located on a walkway according to example aspects of the present disclosure. One or more portion(s) of the method 400 can be implemented by a computing system that includes one or more computing devices such as, for example, the computing systems described with reference to the other figures (e.g., a LEV computing system 100, a remote computing system 190, etc.). Each respective portion of the method 400 can be performed by any (or any combination) of one or more computing devices. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 4 is described with reference to elements/terms described with respect to other systems and figures for example illustrated purposes and is not meant to be limiting. One or more portions of method 400 can be performed additionally, or alternatively, by other systems.

At 410, the method 400 can include obtaining sensor data from a sensor located onboard an autonomous LEV. For example, in various implementations, the sensor data can include accelerometer data, image data, radio beacon sensor data, GPS data, or other sensor data obtained from a sensor located onboard the autonomous LEV. In some implementations, the sensor data can be obtained by a remote computing system, such as via a communications network.

At 420, the method 400 can include determining that the autonomous LEV is located on a walkway based at least in part on the sensor data. For example, in some implementations, the sensor data can include accelerometer data, and the computing system can analyze the accelerometer data for a walkway signature waveform, as disclosed herein.

In some implementations, the computing system can analyze one or more images using a machine-learned model. For example, in some implementations, an image segmentation model can be used to analyze one or more images to determine that the autonomous LEV is located on the walkway. In some implementations, a position identifier recognition model can analyze the one or more images to determine a location of the autonomous LEV, such as by recognizing one or more QR codes in the one or more images. In some implementations, a visual localization model can analyze the one or more images to determine a location of the autonomous LEV by comparing the one or more images to an image map. For example, the image map can be generated based at least in part on a plurality of images of a geographic area, such as a plurality of aerial images obtained from above the geographic area, or a plurality of street-view images obtained from a street-level perspective of the geographic area.

In some implementations, the computing system can determine that the autonomous LEV is located on a walkway by analyzing a strength of a signal received from one or more radio beacons to determine a location of the autonomous LEV. For example, the sensor data can include signals from one or more Bluetooth low energy beacons positioned at known locations, and the computing system can determine the location of the autonomous LEV by analyzing the strength of the signal from the Bluetooth low energy beacons.

In some implementations, the computing system can determine that the autonomous LEV is located on a walkway by determining that the autonomous LEV is located in a geographic area which includes one or more walkways.

In some implementations, the computing system can determine that the autonomous LEV is located on the walkway based at least in part on sensor data from a plurality of sensors, such as by inputting sensor data from a plurality of sensors into a state estimator.

At 430, the method 400 can include determining a section of the walkway in which the autonomous LEV is located based at least in part on the sensor data. For example, a walkway can include a frontage zone, a pedestrian throughway, a furniture zone, and/or a bicycle lane. In some implementations, an image segmentation model can be trained to detect various sections of the walkway. In some implementations, the computing system can determine in which section the autonomous LEV is located based on the location of the autonomous LEV and correlating the location of the autonomous LEV to walkway section data, such as walkway section data stored in a map database.

At 440, the method 400 can include obtaining feedback associated with a rider operating the autonomous LEV on the walkway. For example, in some implementations, a push notification can be sent to a user computing device, such as a rider's smart phone, to request feedback as to why the rider is operating the autonomous LEV on the walkway. For example, an obstruction in a roadway or designated travel lane may be preventing the rider from operating the autonomous LEV in the roadway or designated travel lane, and therefore the rider operated the autonomous LEV on a walkway. In some implementations, upon receiving a request for feedback, the user can provide feedback indicating that the obstruction was the reason for operating the autonomous LEV on a walkway.

In some implementations, the feedback can include feedback associated with a travel way condition (e.g., an obstruction, a pothole, etc.), feedback associated with a weather condition (e.g., rain, snow, ice, etc.), and/or feedback associated with a congestion level of the walkway (e.g., zero congestion, low congestion, normal/typical congestion, heavy congestion, etc.). For example, a municipality may allow operation on a walkway in limited situations, such as when a designated travel way (e.g., a bicycle lane) is obstructed (e.g., a vehicle is parked in the bicycle lane), and a rider can provide feedback indicating that such an obstruction is present. For example, in certain weather conditions, a municipality may allow operation on a walkway (e.g., in rain), and a rider can provide feedback associated with the weather condition (e.g., feedback indicating it is currently raining). Similarly, a municipality may allow walkway operation when the walkway is otherwise unoccupied by pedestrians (e.g., zero congestion), and a rider can provide feedback indicating that the walkway is clear (e.g., zero congestion).

At 450, the method 400 can include communicating a notice associated with the feedback to an infrastructure manager or storing the feedback in an infrastructure database. For example, in some implementations, a particular roadway obstruction may cause one or more autonomous LEV riders to travel on a walkway to navigate around the roadway obstruction. In some implementations, a notice associated with the feedback, such as a notice of the roadway obstruction, can be provided to an infrastructure manager, such as the municipality, to make the municipality aware of the condition. Additionally, in some implementations, upon receiving feedback from such riders, the feedback indicative of the roadway obstruction can be stored in an infrastructure database. Further, the feedback can be aggregated and analyzed to highlight problematic infrastructure areas. For example, a list of the areas with the highest instances of autonomous LEV walkway operation and/or the rider-provided feedback associated with such instances of autonomous LEV walkway operation can be provided to a municipality to help identify infrastructure problems and their causes.

At 460, the method 400 can include determining a control action to modify an operation or a position of the autonomous LEV. For example, in some implementations, the control action can be determined based at least in part on a compliance parameter. For example, a particular municipality may not allow walkway operation for LEVs, or may only allow walkway operation under certain circumstances, such as below a threshold speed or during certain times of the day. The computing system can determine the control action to modify the operation or position of the autonomous LEV to comply with the compliance parameter. For example, in some implementations, a maximum speed of the autonomous LEV can be controlled to below a speed threshold, and/or the autonomous LEV can be controlled to a stop during unauthorized times.

In some implementations, an autonomous LEV may be parked in an unauthorized parking location, and a push notification can be sent to a rider to alert the rider to move the autonomous LEV. For example, a notification can include an incentive to relocate the autonomous LEV to an authorized parking location (e.g., a reduced fare on a future rental) and/or a disincentive should the rider not move the autonomous LEV to the authorized parking location (e.g., a penalty).

In some implementations, a relocation request can be sent to a relocation service. For example, an autonomous LEV fleet operator may employ or contract with one or more relocation technicians who can manually relocate autonomous LEVs to authorized parking spots as part of a relocation service. In some implementations, a relocation request can be communicated to the relocation service, such as a current location of the autonomous LEV, and a relocation technician can be dispatched to move the autonomous LEV to an authorized parking location.

In some implementations, the autonomous LEV can autonomously move to a different location. For example, an autonomous LEV (and/or a remote computing system) can detect that an autonomous LEV is parked on an unauthorized section of a walkway, such as a pedestrian throughway, and autonomously move to an authorized section of the walkway, such as a furniture zone.

In some implementations, the computing system can determine the control action to modify the operation or the location of the autonomous LEV based at least in part on a rider history. For example, the rider history can include a history of previous unauthorized walkway operation, such as during the current session (e.g., current rental/ride) or from one or more previous sessions (e.g., previous rentals/rides). For example, should a rider accrue to many walkway operation violations, a rider can be prevented from operating (e.g., renting) an autonomous LEV at a future time. For example, the rider's account can be locked for threshold time period (e.g., a “cooldown” period). Additionally, should a rider be alerted to an unauthorized walkway operation violation, but continue to operate the autonomous LEV on the walkway, a subsequent control action can be escalated, as will be discussed in greater detail with reference to FIG. 5.

In some implementations, the computing system can determine a control action to modify the operation or the location of the autonomous LEV based at least in part on rider feedback. For example, a request for feedback can be communicated to a computing device associated with a rider of the autonomous LEV (e.g., the rider's smartphone), and the control action can be determined based at least in part on the rider feedback. For example, walkway operation of an autonomous LEV may normally not be allowed in a particular area. However, a rider may indicate that an obstruction (e.g., a parked vehicle) is preventing the rider from traveling on an authorized travel way (e.g., a bicycle lane). In such a situation, a municipality may allow temporary operation on the walkway, and the computing system can determine that limited operation on the walkway may be allowed, such as at a reduced speed or for a limited distance. In such a case, the computing system can control the autonomous LEV by, for example, limiting the speed of the autonomous LEV and/or only allowing operation on the walkway for the limited distance. For example, if the rider continues to operate the autonomous LEV on the walkway beyond the limited distance, the computing system can control the autonomous LEV to a stop.

At 470, the method 400 can include implementing the control action. For example, the computing system can send a push notification to a computing device associated with a rider (e.g., a walkway violation alert), adjust an operating speed of the autonomous LEV (e.g., reduce the speed below a threshold), control the autonomous LEV to a stop (e.g., ceasing operation), prevent a rider from riding an autonomous LEV at a future time (e.g., disable an account, such as for a certain time period due to repeated violations), send a relocation request to a relocation service (e.g., to relocate the autonomous LEV to a designated parking area), autonomously move the autonomous LEV (e.g., to relocate the autonomous LEV to a designated parking area) and/or other control actions, as described herein.

FIG. 5 depicts a flow diagram of an example control action decision tree 500 for determining and implementing a control action according to example aspects of the present disclosure. One or more portion(s) of the decision tree 500 can be implemented by a computing system that includes one or more computing devices such as, for example, the computing systems described with reference to the other figures (e.g., a LEV computing system 100, a remote computing system 190, etc.). Each respective portion of the decision tree 500 can be performed by any (or any combination) of one or more computing devices. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for example illustrated purposes and is not meant to be limiting. One or more portions of decision tree 500 can be performed additionally, or alternatively, by other systems.

At 502, a computing system can obtain sensor data. The sensor data can be, for example, inertial measurement unit/accelerometer data, image data, RADAR data, LIDAR data, radio beacon sensor data, GPS sensor data, and/or other data acquired by the vehicle sensor, as described herein. The sensor data can be obtained, for example, directly from the sensors by a computing system onboard an autonomous LEV, and/or the sensor data can be obtained by a remote computing system, such as via a communications network.

At 504, the computing system can analyze the sensor data. For example, as described herein, the sensor data can be of analyzed by the computing system to detect a walkway signature waveform; analyzed by one or more machine-learned models, such as image segmentation models, position identifier models, and/or visual localization models; analyzed to determine a location, such as using GPS data and/or radio beacon sensor signal strength data; analyzed using a state estimator; or other sensor data analysis.

At 506, the computing system can determine whether the autonomous LEV is located on a walkway. If not, at 508, the computing system can continue normal operation of the autonomous LEV. In some implementations, the computing system can also determine a section of the walkway in which the autonomous LEV is located.

If the autonomous LEV is on a walkway at 506, then at 510 the computing system can determine whether a rider is present. For example, the computing system can determine whether a rider is present by determining whether a rider has been provided access to the autonomous LEV (e.g., the rider has rented the autonomous LEV), or using various sensors, such as weight sensors, wheel encoders, speedometers, GPS data, etc. For example, if the autonomous LEV has been rented, is in a manual operation mode, and/or is currently moving, the computing system can determine that a rider is present. If the autonomous LEV is stationary, has not been rented, and/or a weight sensor indicates no one is onboard the autonomous LEV, the computing system can determine that a rider is not present.

If a rider is not present, then at 512, the computing system can determine whether the autonomous LEV is located in a correct (e.g., authorized) section of the walkway. For example, a municipality may only allow autonomous LEVs to be parked in a furniture zone of a walkway. If the autonomous LEV is parked in an incorrect section, such as a pedestrian throughway or a frontage zone, then at 514, the computing system can move the autonomous LEV. For example, in various implementations, a push notification can be sent to a rider's computing device (e.g., smart phone) alerting the rider to move the autonomous LEV, a relocation request can be communicated (e.g., sent) to a relocation service for a relocation technician to manually move the autonomous LEV, and/or the autonomous LEV can be autonomously moved to the correct section, such as the furniture zone and/or a designated parking location.

If at 512 the autonomous LEV is located in the correct section, then at 516, the computing system can take no control action.

In some implementations, the computing system can determine whether the autonomous LEV is located in a correct section of the walkway when a rider is present (not depicted in FIG. 5). For example, in some implementations, a municipality may include one or more designated travel paths, such as bicycle lanes, as sections of a walkway. During operation, the computing system can determine whether the autonomous LEV is located in the correct section, such as the bicycle lane, while the autonomous LEV is operating. If the autonomous LEV is located in the correct section, then the computing system can take no control action. If, however, the LEV is located in the correct section, then the computing system can implement any number of control actions, such as the control actions disclosed herein.

If at 510 a rider is present, then at 518, the computing system can obtain feedback. For example, a request for feedback can be communicated to a rider's computing device (e.g., smartphone) requesting feedback, and the rider can provide feedback by, for example, making one or more feedback selections in a user interface operating on the rider's computing device. The feedback can then be communicated by the user's computing device to the computing system.

If at 520, the feedback is an acceptable reason for walkway operation, then at 522, the computing system can allow normal operation of the autonomous LEV. For example, if a rider is prevented from traveling on a designated travel path, such as due to an obstruction blocking the designated travel path, the computing system can allow the autonomous LEV to continue operating normally. In some implementations, the computing system may allow normal operation subject to one or more constraints, such as only allowing normal operation on the walkway for a limited distance and/or at a limited speed.

Further, at 524, the computing system can report and/or log the condition. For example, the computing system can provide a notice to an infrastructure manager, such as a municipality, that the obstruction prevented the rider from traveling on the designated travel path, as disclosed herein. In some implementations, feedback from a plurality of riders can be aggregated and provided to the infrastructure manager, as disclosed herein.

If at 520 the rider feedback was not an acceptable reason, then at 526, the computing system can send a push notification to a user computing device associated with rider, such as the rider's smart phone. Similarly, in some implementations, the obtaining feedback step 518 can be skipped and if a rider is present at 510, the computing system can send a push notification at 526. The push notification can alert the rider to a walkway operation violation. For example, the push notification can explain that walkway operation is not allowed on one or more particular walkways, such as due to a restriction. In some implementations, the push notification can be sent to and/or provided to a human machine interface onboard the autonomous LEV. For example, a push notification can be sent from a remote computing system to the autonomous LEV and/or communicated from the light electric vehicle computing system, where it can be displayed on a display screen of the autonomous LEV.

At 528, the computing system can determine whether the autonomous LEV is still located on the walkway. For example, the computing system can obtain additional sensor data, analyze the additional sensor data, and determine whether the autonomous LEV is located on a walkway and/or located in a particular walkway section based at least in part on the additional sensor data. If at 528 the autonomous LEV is no longer on the walkway, then at 530, the computing system can allow normal operation of the autonomous LEV.

If, however, at 528 the autonomous LEV is still located on the walkway, then at 532 the computing system can reduce the operating speed of the autonomous LEV. For example, if a municipality allows operation of autonomous LEVs on walkways at or below a particular speed threshold, the computing system can control the autonomous LEV to at or below the speed threshold. In some implementations, if a municipality does not allow operation of an autonomous LEV on a walkway at any speed, then the speed can be reduced to allow for subsequent sensor data to be obtained.

At 534, the computing system can determine whether the autonomous LEV is still located on the walkway. For example, the computing system can obtain additional sensor data, analyze the additional sensor data, and determine whether the autonomous LEV is located on a walkway and/or located in a particular walkway section based at least in part on the additional sensor data. If at 534 the autonomous LEV is no longer on the walkway, then at 536, the computing system can allow normal operation of the autonomous LEV.

If, however, at 534, the autonomous LEV is still located on the walkway then at 538, the computing system can cease operation of the autonomous LEV. For example, the computing system can control the autonomous LEV to a stop. The autonomous LEV can be prevented from operating under power while on the walkway. For example, the autonomous LEV can enter a push mode in which a rider may only manually move the autonomous LEV. For example, powered operation can be prevented until such time as the rider has moved the autonomous LEV off of the walkway.

At 540, the computing system can determine whether the rider has exceeded a violations threshold. For example, the computing system can access a rider history, which can include previous instances of walkway operation violations. In some implementations, the violations threshold can be for a particular time period, such as a number of walkway violations over a day, a week, a month, etc. In some implementations, the violations threshold can be for a particular session. For example, a rider may rent an autonomous LEV to travel in a downtown area, and the violations threshold may be used for the rental session.

If the rider has not exceeded the violations threshold at 540, then at 542 the computing system can allow future rider operation. For example, the rider can be allowed to continue renting autonomous LEVs from an autonomous LEV fleet owner.

If the rider has exceeded the violations threshold at 540, then at 544, the computing system can prevent future rider operation. For example, the rider can be prevented from renting autonomous LEVs from the autonomous LEV fleet owner, such as for a threshold time period (e.g., a “cooldown” time period). For example, the rider's account can be locked for the threshold time period.

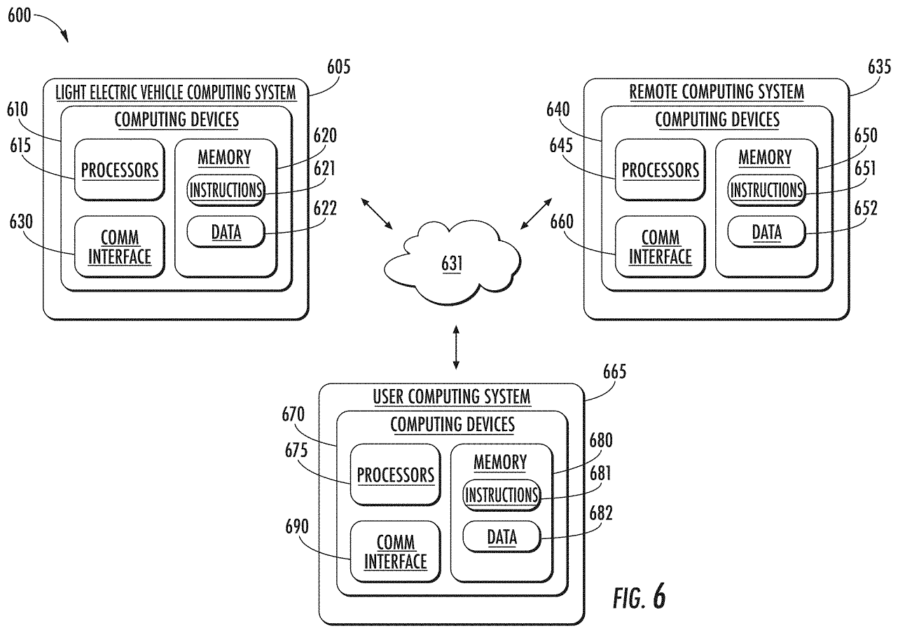

FIG. 6 depicts an example system 600 according to example aspects of the present disclosure. The example system 600 illustrated in FIG. 6 is provided as an example only. The components, systems, connections, and/or other aspects illustrated in FIG. 6 are optional and are provided as examples of what is possible, but not required, to implement the present disclosure. The example system 600 can include a light electric vehicle computing system 605 of a vehicle. The light electric vehicle computing system 605 can represent/correspond to the light electric vehicle computing system 100 described herein. The example system 600 can include a remote computing system 635 (e.g., that is remote from the vehicle computing system). The remote computing system 635 can represent/correspond to a remote computing system 190 described herein. The example system 600 can include a user computing system 665 (e.g., that is associated with a user/rider). The remote computing system 635 can represent/correspond to a user computing system 195 described herein. The light electric vehicle computing system 605, the remote computing system 635, and the user computing system 665 can be communicatively coupled to one another over one or more network(s) 631.

The computing device(s) 610 of the light electric vehicle computing system 605 can include processor(s) 615 and a memory 620. The one or more processors 615 can be any suitable processing device (e.g., a processor core, a microprocessor, an ASIC, a FPGA, a controller, a microcontroller, etc.) and can be one processor or a plurality of processors that are operatively connected. The memory 620 can include one or more non-transitory computer-readable storage media, such as RAM, ROM, EEPROM, EPROM, one or more memory devices, flash memory devices, data registrar, etc., and combinations thereof.

The memory 620 can store information that can be accessed by the one or more processors 615. For instance, the memory 620 (e.g., one or more non-transitory computer-readable storage mediums, memory devices) on-board the vehicle can include computer-readable instructions 621 that can be executed by the one or more processors 615. The instructions 621 can be software written in any suitable programming language or can be implemented in hardware. Additionally, or alternatively, the instructions 621 can be executed in logically and/or virtually separate threads on processor(s) 615.

For example, the memory 620 can store instructions 621 that when executed by the one or more processors 615 cause the one or more processors 615 (the light electric vehicle computing system 605) to perform operations such as any of the operations and functions of the LEV computing system 100 (or for which it is configured), one or more of the operations and functions for detecting walkways and determining/implementing control actions for an autonomous LEV, one or more portions of method 400 and decision tree 500, and/or one or more of the other operations and functions of the computing systems described herein.

The memory 620 can store data 622 that can be obtained (e.g., acquired, received, retrieved, accessed, created, stored, etc.). The data 622 can include, for instance, sensor data map data, compliance parameter data, vehicle state data, perception data, prediction data, motion planning data, data associated with a vehicle client, data associated with a service entity's telecommunications network, data associated with an API, data associated with a library, data associated with user interfaces, data associated with user input, data associated with rider feedback, and/or other data/information such as, for example, that described herein. In some implementations, the computing device(s) 610 can obtain data from one or more memories that are remote from the light electric vehicle computing system 605.

The computing device(s) 610 can also include a communication interface 630 used to communicate with one or more other system(s) on-board a vehicle and/or a remote computing device that is remote from the vehicle (e.g., of the system 635 and/or 665). The communication interface 630 can include any circuits, components, software, etc. for communicating via one or more networks (e.g., network(s) 631). The communication interface 630 can include, for example, one or more of a communications controller, receiver, transceiver, transmitter, port, conductors, software and/or hardware for communicating data.

The remote computing system 635 can include one or more computing device(s) 640 that are remote from the light electric vehicle computing system 605. The computing device(s) 640 can include one or more processors 645 and a memory 650. The one or more processors 645 can be any suitable processing device (e.g., a processor core, a microprocessor, an ASIC, a FPGA, a controller, a microcontroller, etc.) and can be one processor or a plurality of processors that are operatively connected. The memory 650 can include one or more tangible, non-transitory computer-readable storage media, such as RAM, ROM, EEPROM, EPROM, one or more memory devices, flash memory devices, data registrar, etc., and combinations thereof.

The memory 650 can store information that can be accessed by the one or more processors 645. For instance, the memory 650 (e.g., one or more tangible, non-transitory computer-readable storage media, one or more memory devices, etc.) can include computer-readable instructions 651 that can be executed by the one or more processors 645. The instructions 651 can be software written in any suitable programming language or can be implemented in hardware. Additionally, or alternatively, the instructions 651 can be executed in logically and/or virtually separate threads on processor(s) 645.

For example, the memory 650 can store instructions 651 that when executed by the one or more processors 645 cause the one or more processors 645 to perform operations such as any of the operations and functions of the remote computing system 190 (or for which it is configured), one or more of the operations and functions for detecting walkways and determining/implementing control actions for an autonomous LEV, one or more portions of method 400 and decision tree 500, and/or one or more of the other operations and functions of the computing systems described herein.

The memory 650 can store data 652 that can be obtained. The data 652 can include, for instance, data associated with autonomous LEV sensors, map data, compliance parameter data, data associated with rider histories (e.g., rider accounts, rider walkway violations, etc.), feedback data, infrastructure data, data to be communicated to autonomous LEVs, data to be communicated to user computing devices, application programming interface data, data associated with vehicles and/or vehicle parameters, data associated with user interfaces, data associated with user input, and/or other data/information such as, for example, that described herein.

The computing device(s) 640 can also include a communication interface 660 used to communicate with one or more system(s) onboard a vehicle and/or another computing device that is remote from the system 635, such as user computing system 665 and light electric vehicle computing system 605. The communication interface 660 can include any circuits, components, software, etc. for communicating via one or more networks (e.g., network(s) 631). The communication interface 660 can include, for example, one or more of a communications controller, receiver, transceiver, transmitter, port, conductors, software and/or hardware for communicating data.

The user computing system 665 can include one or more computing device(s) 670 that are remote from the light electric vehicle computing system 605 and the remote computing system 635. The computing device(s) 670 can include one or more processors 675 and a memory 680. The one or more processors 675 can be any suitable processing device (e.g., a processor core, a microprocessor, an ASIC, a FPGA, a controller, a microcontroller, etc.) and can be one processor or a plurality of processors that are operatively connected. The memory 680 can include one or more tangible, non-transitory computer-readable storage media, such as RAM, ROM, EEPROM, EPROM, one or more memory devices, flash memory devices, data registrar, etc., and combinations thereof.

The memory 680 can store information that can be accessed by the one or more processors 675. For instance, the memory 680 (e.g., one or more tangible, non-transitory computer-readable storage media, one or more memory devices, etc.) can include computer-readable instructions 681 that can be executed by the one or more processors 675. The instructions 681 can be software written in any suitable programming language or can be implemented in hardware. Additionally, or alternatively, the instructions 681 can be executed in logically and/or virtually separate threads on processor(s) 675.

For example, the memory 680 can store instructions 681 that when executed by the one or more processors 675 cause the one or more processors 675 to perform operations such as any of the operations and functions of the user computing system 195 (or for which it is configured), one or more of the operations and functions for providing rider feedback, one or more of the operations and functions for receiving push notifications, one or more of the operations and functions for detecting walkways and determining/implementing control actions for an autonomous LEV, one or more portions of method 400 and decision tree 500, and/or one or more of the other operations and functions of the computing systems described herein.

The memory 680 can store data 682 that can be obtained. The data 682 can include, for instance, data associated with the user (e.g., autonomous LEV rider account data, rider history data, rider walkway violations, etc.), feedback data, data to be communicated to autonomous LEVs, data to be communicated to remote computing devices, application programming interface data, data associated with user interfaces, data associated with user input, and/or other data/information such as, for example, that described herein.

The computing device(s) 670 can also include a communication interface 690 used to communicate with one or more system(s) onboard a vehicle and/or another computing device that is remote from the system 665, such as remote computing system 665 and/or light electric vehicle computing system 605. The communication interface 690 can include any circuits, components, software, etc. for communicating via one or more networks (e.g., network(s) 631). The communication interface 690 can include, for example, one or more of a communications controller, receiver, transceiver, transmitter, port, conductors, software and/or hardware for communicating data.

The network(s) 631 can be any type of network or combination of networks that allows for communication between devices. In some embodiments, the network(s) 631 can include one or more of a local area network, wide area network, the Internet, secure network, cellular network, mesh network, peer-to-peer communication link and/or some combination thereof and can include any number of wired or wireless links. Communication over the network(s) 631 can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for determining an autonomous light electric vehicle location, comprising:
obtaining, by a computing system comprising one or more computing devices, sensor data from a sensor located onboard an autonomous light electric vehicle;
determining, by the computing system, that the autonomous light electric vehicle is located on a walkway based at least in part on the sensor data;
in response to determining that the autonomous light electric vehicle is located on the walkway, determining, by the computing system, a control action to modify an operation or a location of the autonomous light electric vehicle; and
implementing, by the computing system, the control action.

2. The computer-implemented method of claim 1, further comprising:
determining, by the computing system, a section of the walkway in which the autonomous light electric vehicle is located based at least in part on the sensor data;
wherein the section of the walkway comprises one of: a frontage zone, a pedestrian throughway, or a furniture zone.

3. The computer-implemented method of claim 2, wherein determining, by the computing system, the control action to modify the operation or the location of the autonomous light electric vehicle comprises determining, by the computing system, the control action based at least in part on the section of the walkway in which the autonomous light electric vehicle is located.

4. The computer-implemented method of claim 1, wherein the sensor data comprises accelerometer data, and wherein determining, by the computing system, that the autonomous light electric vehicle is located on the walkway based at least in part on the sensor data comprises analyzing the accelerometer data for a walkway signature waveform.

5. The computer-implemented method of claim 1, wherein the sensor data comprises one or more images obtained from a camera located onboard the autonomous light electric vehicle, and wherein determining, by the computing system, that the autonomous light electric vehicle is located on the walkway based at least in part on the sensor data comprises analyzing the one or more images using machine-learned model to determine the autonomous light electric vehicle is located on the walkway;
wherein the machine-learned model comprises an image segmentation model which has been trained to detect a walkway or a walkway section using training data comprising a plurality of images labelled with walkway or walkway section annotations.

6. The computer-implemented method of claim 1, wherein the sensor data comprises one or more images obtained from a camera located onboard the autonomous light electric vehicle, and wherein the one or more images comprise one or more images depicting one or more position identifiers of a plurality of position identifiers;
wherein determining, by the computing system, that the autonomous light electric vehicle is located on the walkway based at least in part on the sensor data comprises analyzing the one or more images using a machine-learned model to determine a location of the autonomous light electric vehicle; and
wherein the machine-learned model comprises a position identifier recognition model which has been trained to determine the location of the autonomous light electric vehicle based at least in part on the one or more position identifiers depicted in the one or more images.

7. The computer-implemented method of claim 1, wherein the sensor data comprises one or more images obtained from a camera located onboard the autonomous light electric vehicle, and wherein determining, by the computing system, that the autonomous light electric vehicle is located on the walkway based at least in part on the sensor data comprises analyzing the one or more images using a machine-learned model to determine a location of the autonomous light electric vehicle;
wherein the machine-learned model comprises a visual localization model which has been trained to determine the location of the autonomous light electric vehicle by comparing the one or more images to an image map; and
wherein the image map comprises a map of a geographic area generated based at least in part on a plurality of images of the geographic area.

8. The computer-implemented method of claim 1, wherein the computing system comprises a computing device located onboard the autonomous light electric vehicle; and
wherein determining, by the computing system, that the autonomous light electric vehicle is located on the walkway based at least in part on the sensor data comprises determining that the autonomous light electric vehicle is located on the walkway based at least in part on the sensor data by the computing device located onboard the autonomous light electric vehicle.

9. The computer-implemented method of claim 1, wherein the computing system comprises a computing device remote from the autonomous light electric vehicle;
wherein obtaining, by the computing system, the sensor data from the sensor located onboard the autonomous light electric vehicle comprises obtaining, by the remote computing device, the sensor data from the autonomous light electric vehicle; and
wherein determining, by the computing system, that the autonomous light electric vehicle is located on the walkway based at least in part on the sensor data comprises determining, by the remote computing device, that the autonomous light electric vehicle is located on the walkway based at least in part on the sensor data.

10. The computer-implemented method of claim 1, further comprising:
obtaining, from a computing device associated with a rider of the autonomous light electric vehicle, feedback associated with the rider operating the autonomous light electric vehicle on the walkway,
wherein determining, by the computing system, the control action to modify the operation or the location of the autonomous light electric vehicle action comprises determining, by the computing system, the control action based at least in part on the feedback, and
wherein the feedback comprises one or more of: feedback associated with a travelway obstruction; feedback associated with a weather condition; or feedback associated with a congestion level of the walkway.

11. A computing system, comprising:
one or more processors; and
one or more tangible, non-transitory, computer readable media that store instructions that when executed by the one or more processors cause the computing system to perform operations, the operations comprising:
obtaining sensor data from a sensor located onboard an autonomous light electric vehicle;
determining that the autonomous light electric vehicle is located on a walkway based at least in part on the sensor data;
in response to determining that the autonomous light electric vehicle is located on the walkway, determining a control action to modify an operation or a location of the autonomous light electric vehicle; and
implementing the control action.

12. The computing system of claim 11, wherein the sensor data comprises a signal received from one or more radio beacons, and wherein determining, by the computing system, that the autonomous light electric vehicle is located on the walkway based at least in part on the sensor data comprises analyzing a strength of the signal received from the one or more radio beacons to determine a location of the autonomous light electric vehicle.

13. The computing system of claim 12, wherein determining, by the computing system, that the autonomous light electric vehicle is located on the walkway based at least in part on the sensor data comprises inputting the sensor data from a plurality of sensors into a state estimator.

14. The computing system of claim 11, wherein implementing, by the computing system, the control action comprises at least one of:
sending a push notification to a computing device associated with a rider of the autonomous light electric vehicle; or
preventing a rider of the autonomous light electric vehicle from operating the autonomous light electric vehicle or another autonomous light electric vehicle at a future time.

15. The computing system of claim 11, wherein implementing, by the computing system, the control action comprises autonomously moving the autonomous LEV to a different location.

16. An autonomous light electric vehicle comprising:
one or more sensors;
one or more processors; and
one or more tangible, non-transitory, computer readable media that store instructions that when executed by the one or more processors cause the computing system to perform operations, the operations comprising:
obtaining sensor data from the one or more sensors;
determining that the autonomous light electric vehicle is located on a walkway based at least in part on the sensor data;
in response to determining that the autonomous light electric vehicle is located on the walkway, determining a control action to modify an operation or a location of the autonomous light electric vehicle; and
implementing the control action.

17. The autonomous light electric vehicle of claim 16, wherein the autonomous light electric vehicle comprises a bicycle or a scooter.

18. The autonomous light electric vehicle of claim 16, wherein the operations further comprise:
determining a section of the walkway in which the autonomous light electric vehicle is located based at least in part on the sensor data.

19. The autonomous light electric vehicle of claim 18, wherein determining the control action to modify the operation or the location of the autonomous light electric vehicle comprises determining the control action based at least in part on the section of the walkway in which the autonomous light electric vehicle is located.

20. The autonomous light electric vehicle of claim 16, wherein the control action comprises autonomously moving the autonomous LEV to a different location.
